(19) United States
(12) Patent Application Publication
(10) Pub. No.: US 2006/0215391 A1
(43) Pub. Date: Sep. 28, 2006

(54) Lighted detail brush

(76) Inventors: Terry G. Jones, Austin, TX (US); Timothy J. Crowley, Marfa, TX (US); Lynn Crowley, Marfa, TX (US)

Correspondence Address: H. DALE LANGLEY, JR.;THE LAW FIRM OF H. DALE LANGLEY, JR. PC, 610 WEST LYNN, AUSTIN, TX, 78703, US

(21) Appl. No.: 11/321,980

(22) Filed: Dec. 29, 2005

Related U.S. Application Data
(63) Continuation-in-part of application No. 11/088,294, filed on Mar. 24, 2005.

(51) Int. Cl. A47L 9/30; F21V 33/00

(52) U.S. Cl. 362/91; 362/109

(57) ABSTRACT

A handheld implement, such as, for example, a brush, detailer, applicator, or the like, includes a housing and a work element connected to the handle. The implement also includes a light, a power source connected to the light, and a switch for turning on and off the power source for illuminating the light. The work element is concealable in the housing when the implement is not in use, and can be extendable from the housing when the implement is in use. The light, via switching the light on or off, selectively illuminates a surface on which the work element of the implement is employed or operates. The work element is, for example, bristles, and the light is a low power bulb or LED.

### CROSS-REFERENCE TO RELATED APPLICATIONS

This application is a continuation-in-part of U.S. patent application Ser. No. 11/088,294, filed on Mar. 24, 2005, titled “Lighted Cleaning Implement”, incorporated herein by this reference.

### BACKGROUND OF THE INVENTION

The present invention generally relates to cleaning implements, such as brooms, mops, whisk brooms, coating applicators, dusters, and brushes and, more particularly, relates to illuminating features incorporated in handheld detail brushes and other implements.

Brushes, brooms, mops, dusters, whisk brooms, and the like are conventionally quite standard, basic, and featureless. Improvements to these conventional implements have typically been limited to varied materials, for example, horsehair, natural straw bristles, cotton, or similar materials as bristles and brush surfaces, mop heads, cleaning surfaces, paint applicators, and wood handles, have been replaced with plastics or other synthetics in certain instances. Notwithstanding these limited improvements, the conventional designs for these implements have remained generally unchanged for many years.

A reason that these conventional designs have remained unchanged is that consumers desire these implements to be fairly inexpensive and primarily functional. In order to limit costs, manufacturers have maintained basic designs, without any significant improvements or new features. Presently, costs for simple electronics have dropped substantially, and requirements to power such electronics have been vastly reduced and miniaturized. For instance, light bulbs, batteries, and circuits have become quite inexpensive to make and maintain. Also, power consumption required for bulbs and circuits, particularly with newer light emitting diodes (LEDs) and similar low-energy lighting components, has been reduced.

It would, therefore, be a significant improvement in the art and technology to improve brush, bristled, and cleaning implements, such as brushes, applicators, brooms, mops, dusters, paint or coating applicators, whisk brooms, and similar devices, to provide lights or illumination sources to the devices. The lights can illuminate an area for service, such as a draftsman's drawing paper/board, a written page, structural crevices, corners, features, under areas, such as a bed, car dashboard, and the like, inside cabinets, in car or transportation cabins or compartments, and otherwise. The present invention provides numerous advantages and improvements, including improvements and nuances in the foregoing respects.

### SUMMARY OF THE INVENTION

An embodiment of the invention is a system for cleaning. The system includes a cleaning element and light connected to the cleaning element.

Another embodiment of the invention is a broom having a handle and bristles connected to the head. The broom includes a light in the handle, a power source connected to the light, and a switch for turning on and off the power source.

Yet another embodiment of the invention is a mop having a handle and a mop head connected to the handle. The mop includes a light in the handle, a power source connected to the light, and a switch for turning on and off the power source.

Another embodiment of the invention is an implement comprising a handle and a cleaning feature connected to the handle. A light is connected to the implement.

Yet another embodiment of the invention is a method of using an implement. The method includes connecting a light to the implement.

Another embodiment of the invention is a method of using an implement. The method includes illuminating by the implement.

A further embodiment of the invention is a system for brushing. The system includes a bristle, a housing containing the bristle, the housing being hand holdable, and a light connected to the housing.

Another embodiment of the invention is a hand implement for work on a surface. The hand implement includes an elongate housing having an operational end, a work element connected to the operational end, a light connected to the housing for selectively illuminating the surface, a power source contained within the housing and connected to the light, and a switch connected to the power source for turning on and off the power source to the light.

Yet another embodiment of the invention is a hand implement for work on a surface. The implement includes parallel sides joined by an end, a wheel rotatably connected between the parallel sides, a work element connected to the periphery of the wheel, a light connected to the wheel for selectively illuminating the surface, a power source connected to the light and contained within the wheel, and a switch connected to the power source for turning on and off the power source to the light.

Another embodiment of the invention is a method of using a hand implement. The method includes connecting a light to a housing, connecting a bristle to the housing, and selectively switching on/off the light.

### BRIEF DESCRIPTION OF THE DRAWINGS

The present invention is illustrated by way of example and not limitation in the accompanying figures, in which like references indicate similar elements, and in which:

FIG. 1 illustrates a side perspective view of a system for cleaning, incorporating a light, according to certain embodiments of the invention;

FIG. 2A illustrates an alternate side perspective view of a system for cleaning, such as that of FIG. 1, incorporating another light, and showing, according to certain embodiments of the invention;

FIG. 2B illustrates a circuit for powering and switching “on” and “off” a light, for example, the lights of the systems of the other Figures herein, according to certain embodiments of the invention

FIG. 3 illustrates a side perspective view of a system for cleaning, incorporating a plurality of lights on the side, according to certain embodiments of the invention;

FIG. 4 illustrates an alternative side perspective view of a system for cleaning, such as that of FIG. 1, incorporating another plurality of lights, according to certain embodiments of the invention;

FIG. 5 illustrates a side perspective view of an alternative system for cleaning, incorporating a light, according to certain embodiments of the invention;

FIG. 6 illustrates a side perspective view of another alternative system for cleaning, incorporating a plurality of lights, according to certain embodiments of the invention;

FIG. 7 illustrates a side perspective view of yet another system for cleaning, incorporating a light and variable positioning of a switch for operating the light, according to certain embodiments of the invention;

FIG. 8 illustrates a side perspective view of an alternative system for cleaning, such as that of FIG. 7, incorporating a plurality of lights, according to certain embodiments of the invention;

FIG. 9 illustrates a side perspective view of a system for cleaning, incorporating a light, according to certain embodiments of the invention; and

FIG. 10 illustrates another side perspective view of system for cleaning, such as that of FIG. 9, incorporating another light, according to certain embodiments of the invention;

FIG. 11 illustrates a side perspective view of an alternative system for cleaning, incorporating a light, according to certain embodiments of the invention;

FIG. 12A illustrates a side perspective view of a system for cleaning, incorporating a light in “off” mode and an alternative switch from that of other embodiments and

FIG. 12B illustrates the system for cleaning of FIG. 12B, incorporating the light in “on” mode and showing activation of the alternative switch by an event, such as movement of the system on a surface, according to certain embodiments of the invention;

FIG. 13 illustrates a system for sweeping and detailing, incorporating a light and bristles in a handheld pen-shaped body, according to certain embodiments of the invention;

FIG. 14A illustrates another system for sweeping and detailing, incorporating a light and bristles, within a swiveling closure shown in “open” position as when the bristles and light are employed, according to certain embodiments of the invention; and

FIG. 14B illustrates the system of FIG. 14A, in closed position with the bristles and light not in use, according to certain embodiments of the invention.

### DETAILED DESCRIPTION

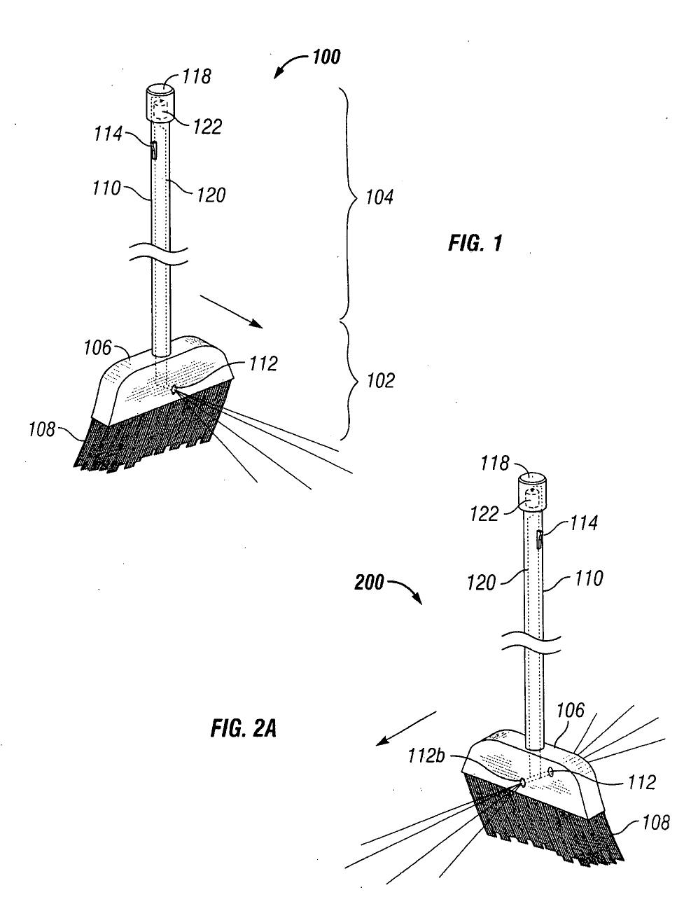

Referring to FIG. 1, a cleaning implement 100 comprises a cleaning head 102 connected to a handle 104. The head 102 comprises a shroud 106 connected to an element 108 for cleaning, for example, broom bristles, mop strings, or duster cloth, or the like. The handle 104 comprises an extension 110 for a human user's manual hand gripping. The extension 110 connects to the shroud 106. The implement 100 incorporates therein and connected therewith a light 112. A switch 114 is connected to and incorporated with the implement 100, such as in the handle 104 or in the head 102. The switch 114 is electrically connected to the light 112 via a powered circuit 120 (shown in phantom in FIG. 1) supplied by a battery 122 (shown in phantom) or other power source for powering the light 102.

In certain embodiments, the shroud 106 is a hood or clamp for retaining the element 108, and is comprised of plastic, wood, metal, or other substantially rigid material(s). The shroud 106 is formed with an opening from within the shroud 106 to outside the shroud 106, to accommodate and retain the light 112 pointing in a direction sufficient to illuminate an area of a surface to be cleaned (to be understood as located beyond the latter end of the implement 100 towards the bottom of FIG. 1). The light 112 is either rigidly retained in the shroud 106 in the applicable pointing direction; or, alternatively, a fixture of the light 112 retained in the shroud 106 allows manual pointing of the light 112 as the application requires.

The element 108 is a plurality of broom bristles, mop strings, or dust cloths, comprised of natural or synthetic materials, retained by the shroud 106 to expose the element 108 to the surface to be cleaned. The handle 104 is a metal or plastic cylinder or other hand grip suitable for handling by the human user via the user's hand(s), and can include ergonomic or usability features, such as an end cap 118 to prevent scratching and other features. The end cap 118 also serves to retain a battery 120 (shown in phantom) for powering the light 112. The end cap 118 is internally threaded to mate with an outward thread of an upper end (in FIG. 1) of the extension 110.

Within the cylinder of the handle 104 and extending through the handle 104 to within the shroud 106, an electrical connector or other power conducting wire or cable interconnects the switch 114, the battery 122, and the light 112, and completes the circuit back to the switch 114. The light 110 is one or more of a filament bulb, light emitting diode (LED), or other illuminator(s). Additionally, the implement 100 can include, incorporated and connected therewith, an external power source (not shown in FIG. 1) for powering the light, if and as required or applicable. The light 112 is, alternately, a fluorescent or other radiating element and does not require any added power source. The power source, where present, is one or more of a DC battery, solar battery, or other source of power sufficient for powering the light 112. In the case of an external power source, a cord to from electrical outlet or other power supply connects to the implement 100 and the implement includes other electrical components for utilizing such power supply.

In operation, a human user handles the implement 100 to perform cleaning by directing the element 108 of the head 102 at or across a surface for cleaning, for example, by gripping the extension 110 and moving the implement 100 to cause the element 108 to pass on the surface (e.g., a floor, wall, etc.) to be cleaned. The light 112 of the implement 100 is selectively switched “on” to illuminate and “off” not to illuminate, by the switch 114. The light 112 is, for example, switched on by the switch 114 when cleaning is performed in a location of low light. The light 112, when switched on, illuminates an area including a portion of the surface being cleaned via the implement 100.

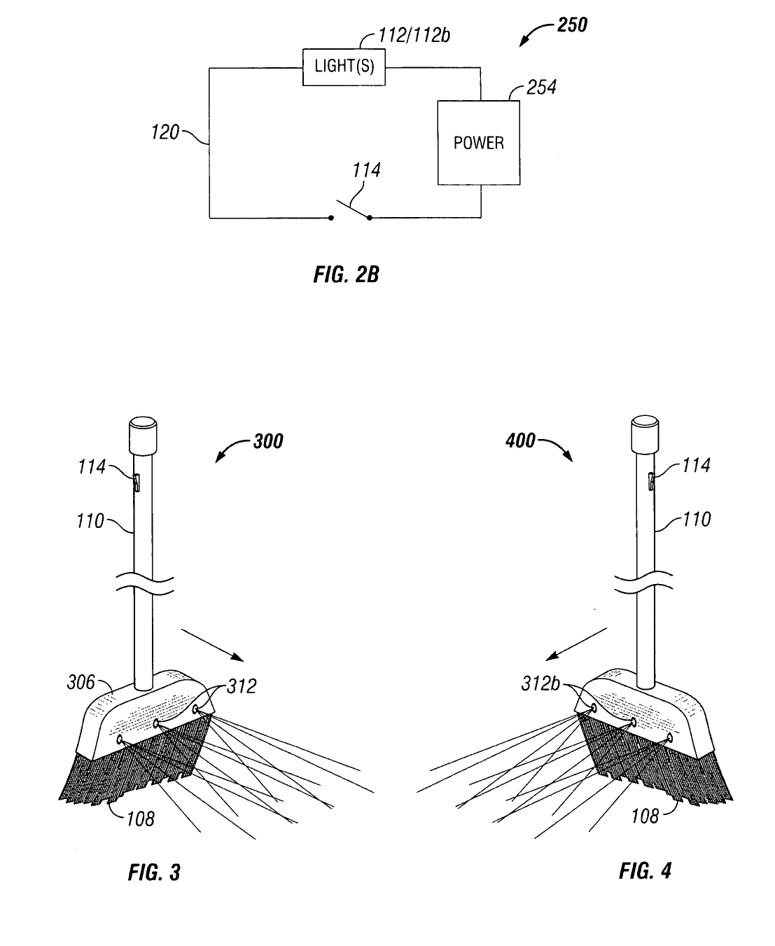

Referring to FIG. 2A, an implement 200, similar to that of FIG. 1, also includes a second light 102b connected to and incorporated in the implement 100 on another side of the implement 100. For example, a broom or mop typically has two or more cleaning approaches that allow back-and-forth (or other directional) swiping movements in cleaning operations. The second light 112b provides illumination of an oppositely (or other directionally) disposed area of the portion of the surface being cleaned. Thus, the implement 200, including the light 112b and the light 112, illuminates areas of the surface to be cleaned on each side of the implement 200.

Referring to FIG. 2B, in conjunction with FIGS. 1 and 2A, a circuit 250 (such as the powered circuit 120 of FIGS. 1 and 2A) for powering the light 112 of the implement 100, and the light 112 and light 112b of the implement 200, is disposed within the implement 100, 200, respectively. The circuit 250 comprises the switch 114 electrically connected to the light 112 of the implement 100 of FIG. 1. The switch 252 is also electrically connected, either in parallel or series as appropriate, to any other light, such as each of the lights 112 and 112b of the implement 200 of FIG. 2A. The light 112 (or lights 112, 112b, where more than one) is electrically connected to a power source 254, for example, the battery 122 of FIGS. 1 and 2A. The power source 254 is retained within the extension 110 or shroud 106 of the implement 100, 200, or is otherwise connected thereto. As previously described, the power source 254 is the battery 122 or other DC source.

Alternately, an AC power source can provide power to the light(s); however, additional appropriate electrical components (for example, appropriate ground, transformer, etc.) are included in the implement 100, 200 or external thereto. In other embodiments, the power source 254 is a rechargeable power source, such as a rechargeable battery; and suitable electrical components, such as an electrical cord connector and a recharging unit, are incorporated with and connected to the implement (or are available external to the implement and are connectable thereto), as desired for the design.

Referring to FIG. 3, an implement 300 includes more than one light 312 (e.g., three lights shown as example in FIG. 3) on a side of the implement 300. The implement 300 is substantially like the implements 100, 200 of FIGS. 1 and 2A,B; however, the powered circuit (not shown in detail) connects the more than one light 312 and the switch 114 powers on and off all or certain of the lights. The more than one light 312 are directed as desired to illuminate a surface to be cleaned.

Referring to FIG. 4, an implement 400, for example, an opposing side of a device like that of FIG. 1, also includes more than one light 312b (e.g., three lights shown as example in FIG. 3) on another side of the implement 400. The powered circuit (not shown in detail) connects the more than one light 312 and the more than one light 312b on the opposing side of the implement 400, and the switch 114 powers on and off all or certain of the lights. The more than one light 312b are also directed as desired to illuminate a surface to be cleaned, such as is applicable for back-and-forth cleaning movements. Although a two-position switch is described as the switch 114 in connection with implements of certain Figures herein, in the case of implements with more than one light, it is to be understood that the switch could include multiple alternatives of “on” and “off” as to lights on a side or sides of the implements and/or as to specific lights of the implements. Those skilled in the art will know and understand that the powered circuit, as well as the power supply and features of the circuit, must be configured and arranged and include appropriate components for each desired configuration and operation.

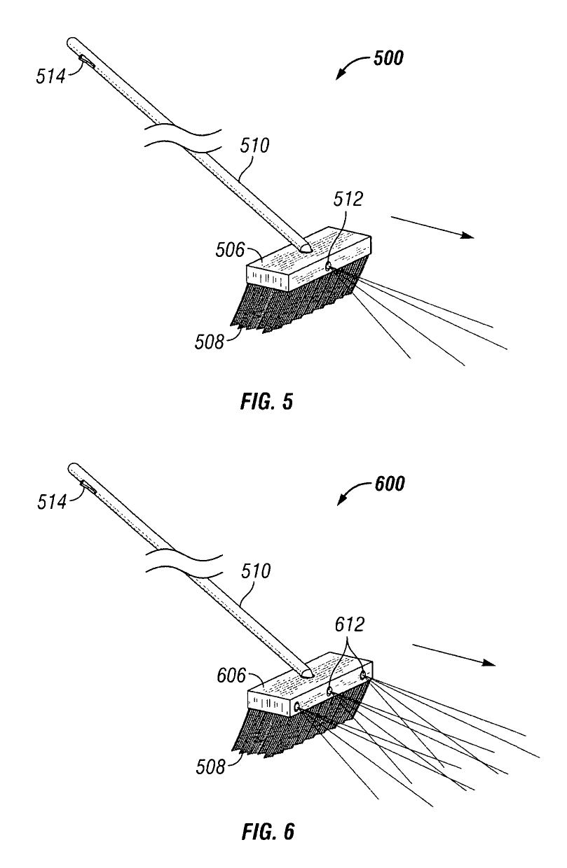

Referring to FIG. 5, another implement 500 also includes an extension 510 connected to a shroud 506. The shroud 506 connects to a cleaning element 508, such as broom bristles. The extension 510 includes a connected switch 514 and the shroud includes a connected light 512. The switch 514 operates the light 512, via a circuit (not shown in detail) and power source of the circuit (not shown in detail).

Referring to FIG. 6, an implement 600, similar to the implement of FIG. 5 but with multiple lights 612 in the shroud 606, provides additional light sources for illumination. The implements 500 (of FIG. 5) and 600 are exemplary of a pushable-pullable cleaning device.

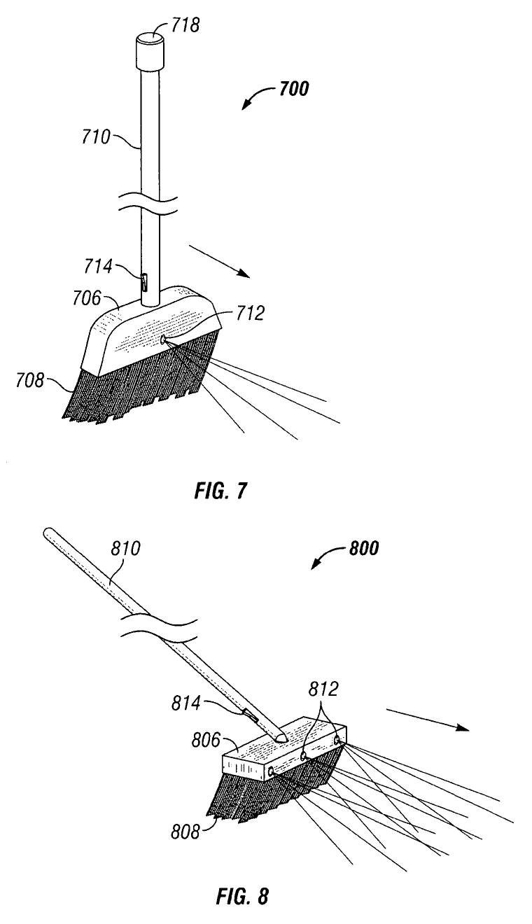

Referring to FIG. 7, an implement 700 includes an extension 710 connected to a shroud 706, retaining protruding cleaning elements 708. The shroud 706 is formed to accommodate and retain a light 712. The extension 710 includes an incorporated power switch 714, for example, near a location of the extension 710 close to the connection of the extension 710 to the shroud 706. The light 712 electrically connects to the switch 714 and a power source (not shown in detail).

Referring to FIG. 8, another implement 800, for example, a pushable-pullable type device, includes an extension 810 connected to a shroud 806. The shroud 806 is connected to and retains a cleaning element 808. The shroud 806 retains more than one light 812, each positioned to illuminate a surface for cleaning. A power switch 814 is incorporated in and connected to the extension 810 near the shroud 806. The more than one light 812 are electrically connected to the switch 814 and a power source (not shown in detail).

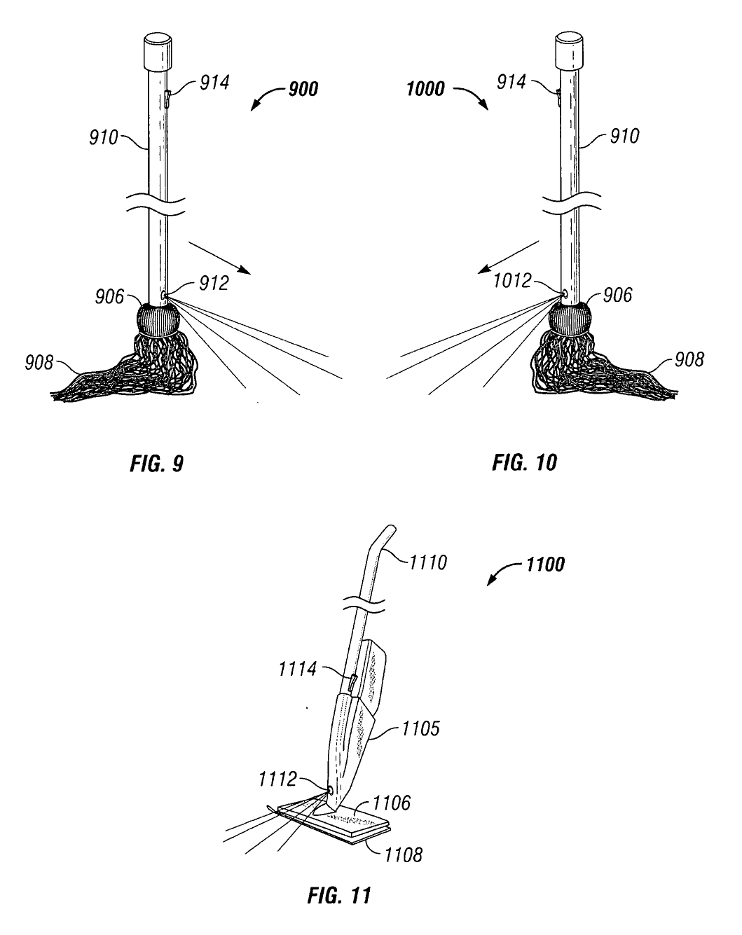

Referring to FIG. 9, a different implement 900, for example, a mop, has a handle extension 910 connected to a head 908, such as strings or yarn, via a connector 906. The handle extension 910 is connected to and incorporated with a power switch 914 and a light 912. The power switch 914 is disposed in an ergonomically suitable location along the handle extension 910 for a user's manual operation. The light 912 is located along the handle extension 910 at a location thereof suitable for the light 912 to illuminate an area for cleaning. The light 912 is electrically connected to the switch 914 and a power source (not shown in detail) in order to complete an on/off circuit for operating the light 912.

Referring to FIG. 10, in conjunction with FIG. 9, another side of an implement 1000, such as the implement 900 of FIG. 9, also includes an additional light 1012 (although two lights 912, 1012 are shown in the implement, multiple lights, beyond two lights, can be included in the implement 1000, with appropriate or desired positioning along the handle extension 910 in order to direct light to a desired area or surface for cleaning). A power circuit, including the switch 914, a power source (not shown in detail), and the light 1012 (and other lights, e.g., light 912, etc.), interconnects these elements for desired on/off operations of the light(s).

Referring to FIG. 11, another cleaning implement 1100, such as a Swiffer™, scraper, painter, or other cleaning element and surface, also includes a light 1112 (or lights, as the case may be). As with the implements previously described, the implement 1100 includes a handle 1110 connected to a cleaning head 1106 and cleaning fixture 1108. The implement 1100 also can, but need not necessarily, include a reservoir 1105, connected to the handle 1110 or otherwise to connect to the fixture 1108 and supply a cleaning substance, for example, soap, paint, or other solid, liquid or gas substance. The light 1112 is incorporated and fixed in the handle 1110 (or, alternatively, at another location of the implement 1100) suitable to illuminate a surface subject to cleaning, painting or other utility operations. Although a single one of the light 1112 is shown, multiple lights and similar orientation are included. Also as with the implements previously described, the switch 1114 electrically connects to the light 1112 and a power source (not shown), and the light 1112 is desirably switchable on and off via the switch 1114 for use of the implement 1100.

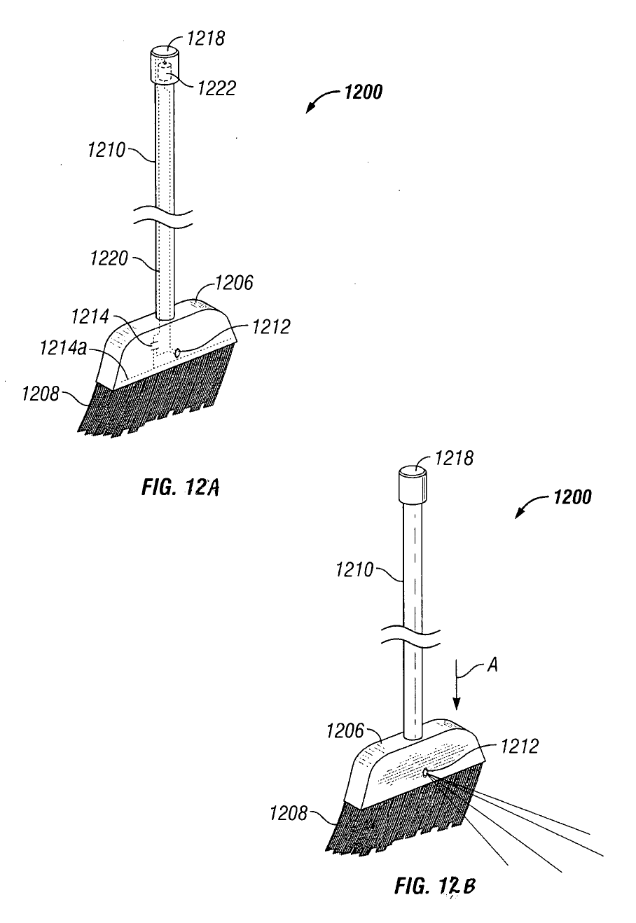

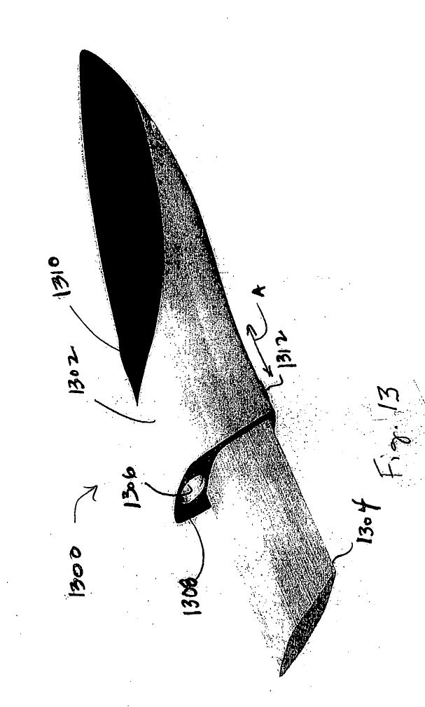

Referring to FIGS. 12A and 12B, an alternative implement 1200 includes a trigger switch 1214 (shown in phantom). This switch 1214 turns “on” whenever a pressure or manipulation occurs to a cleaning element 1208. The implement 1200 has a handle 120, connected to a shroud 1206, and the shroud 1206 retains connected thereto the cleaning element 1208. Retained in and connected to the shroud 1206 is a light 1212 (i.e., a single light or more than one light, as applicable and desired). A trigger feature 1214a of the switch 1214 touches or is otherwise associatedly related or configured to operate “on” whenever the cleaning element 1208 is employed in cleaning operations. For example, when the implement 1200 is not in use for cleaning, the light 1212 is “off” because the cleaning element 1208 is not in contact with a cleaning surface as in FIG. 12A; however, whenever the cleaning element 1208 contacts the cleaning surface, as in FIG. 12B, the switch 1214 is switched “on” and the light 1212 illuminates. The switch 1214 is any of a wide variety of switch possibilities, wherein a pressure, force, movement, or other event (e.g., downward push in the direction of arrow A) as to the cleaning element 1208 causes the switch 1214 to be triggered and turned “on”. As in the prior descriptions of the various other implements and embodiments, the switch 1214 is connected to the light 1212 and each is electrically connected to a power source 1222 by a circuit 1220. The power source 1222 can be a battery or other source, either internal or external to the implement 1200. An access cap 1218 permits access to the power source 1222 and/or other internals of the implement 1200 as configured and desired for the particular use application.

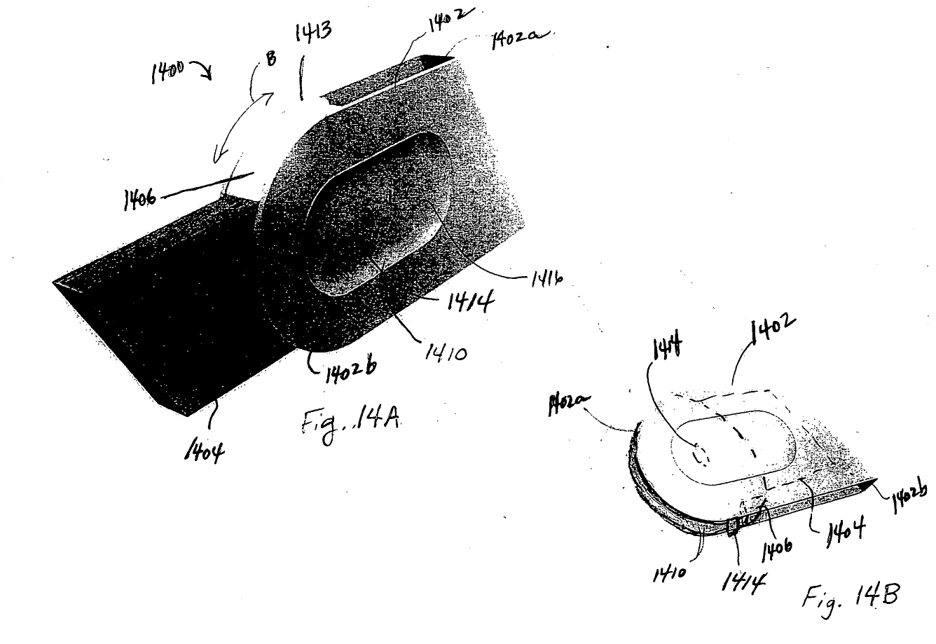

Referring to FIG. 13, a system for detailing and cleaning includes a housing 1300, with bristles 1304 and a light 1306 at an end 1308 of the housing 1300. The housing 1300 is, for example, generally pen-shaped, having a length on the order of that of a writing pen and having a girth that can be slightly larger than that of a writing pen. The housing 1300 can have a shape, such as a narrower end opposite the end 1308, or other design as desired. The end 1308 can, likewise, have a shape, such as an angled planar design or other desired configuration.

The bristles 1304 are retained at and, in certain configurations, within an indentation (not shown in detail) of, the end 1308. The light 1306 is also retained at or within an opening of the end 1308. The light 1306 is lodged at the end 1308 in a manner to illuminate a surface on which the bristles 1304 are swept during cleaning or the like. Although not detailed in the Figure, the bristles 1304 can be retractable from the open/in-use position (as shown in the Figure). For example, a tab 1312 that slides along a slit (not shown) of the housing 1302 in the directions of arrow “A” can allow for selective retraction and extension of the bristle surfaces in order to provide desired bristle 1304 access for use, storage and the like.

In certain arrangements, the housing 1302 is formed of an ABS plastic and a PVC or elastomeric santoprene portion is melded with the plastic as a grip. Of course, any other similar somewhat rigid materials, such as wood, steel, other plastic or synthetic, is suitable. Moreover, the grip portion need not be of a different material or configuration than all other portions of the housing 1302, and/or the housing can be differently shaped or provided with other and alternative features. The bristles 1304 are any type of materials that perform sweeping, cleaning, application or other desired uses, and can be of suitable configuration and makeup for such uses. The bristles 1304 are retained at the end 1308 by glue, retention mechanism, gripping, or any other desired attachment. The light 1306 is, for example, a low-power bulb, such as an LED or the like.

Although not shown in detail in FIG. 13, the housing 1302 contains a power source, such as a battery sufficient to power the light 1306, and a circuit that includes a switch. The switch permits on/off of the circuit and power to the light 1306, as selectively desired by a user of the system 1300. In the Figure, the housing 1302, at the portion that is elastomeric, covers the switch at the location indicated as 1310 (hereinafter referred to as the “switch”, but to be understood as showing in the Figure a possible design for enabling access to the switch by the user). Alternately, the switch 1310 can be located along another area of the housing 1302, and can be otherwise designed, including, for example, the switch 1310 could protrude through an opening of the housing or otherwise accessible to the user. The housing 1302 is formed as a fixed enclosure, such that the system 1300 can be disposed of once power is exhausted, or can include pieces and opening options to access the inside of the enclosure to replace a power source, light, bristles, or other maintenance or application.

In operation, the system 1300 is retained in a user's hand (or otherwise manipulated). The bristles 1304 are extended by means of sliding the tab 1312 towards the end 1308 along the slit of the housing 1302, as illustrated in extended position in FIG. 13. If lighting of an area for brushing by the bristles 1304 is desired, the use presses the switch 1310 and turns “on” the light 1306. By again pressing the switch 1310, the light 1306 is turned “off” to illuminate a surface at the working surface of the bristles 1304. When brushing is completed, the user slides the tab 1312 along the slit of the housing 1302 away from the end 1308, thereby retracting the bristles 1304 into the housing 1302 for shielding of the bristles 1304 during non-use. Of course, the system 1300 can also serve as a lighting source, by turning “on” and “off” the light 1306 via the switch 1310, whether or not the bristles 1304 are extended or retracted or used or not.

Referring to FIG. 14A, another system 1400 for detailing and cleaning includes a outer case 1402, bristles 1404, and a light 1406. The outer case 1402 has two parallel sides 1402b joined by an end 1402a. The parallel sides 1402b are each generally semicircular opposite the end 1402a. Pivotally attached between the parallel sides 1402b is a wheel 1410. The wheel 1410 retains the bristles 1404, for example, in a detention of or otherwise affixed to the circumferential periphery of the wheel 1410. The bristles 1404 extend from and along the circumferential periphery of the wheel 1410 by a measure less than a width of the parallel sides 1402b. As will be described, the bristles can be retained internally between the parallel sides 1402b, when the system 1400 and/or bristles are not being used for detailing, cleaning, application or similar service.

Also inset along the circumferential periphery of the wheel 1410 is a light 1406. The light 1306, or a transparent/translucent screen for the light 1306, can form a portion of the wheel 1410 or otherwise to continue the generally round, circumferential shape of the wheel 1410. The wheel 1410 is pivotal, in the directions of arrow “B”, either to expose the bristles 1404 and light 1306 from between the parallel sides 1402b (such as when the system 1400 is in use) or to rotate the wheel 1410 such that the bristles 1404 and light 1406 are generally maintained between the parallel sides 1402b (such as when the system 1400 is not in use).

FIG. 14B shows the wheel 1410 rotated such that the bristles 1404 and the light 1406 are retained between the parallel sides 1402b.

In FIG. 14A, in conjunction with FIG. 14B, the bristles 1404 and the light 1306 are rotated via the wheel 1410, such that the bristles 1404 extend outwardly and the light 1406 is exposingly positioned for illuminating a working surface for brushing or the like by the bristles 1404. An “on” switch (shown generally in phantom) at about the point 1414 is internal to the system 1400 but is operable by pressing at the point 1414 against the side 1402. This activates the light 1406 to “on” when the wheel 1410 is so rotated to this position of the Figure and the point 1410 is pressed. The light 1406 thereby illuminates a surface on which the bristles 1404 are swept during cleaning or the like. A rotation tab 1412 is positioned at the periphery of the wheel 1410 to apply a rotational movement to the wheel 1410, via a user pushing the tab to rotate the wheel 1410. By rotating the wheel 1410 to the position of FIG. 14A the bristles 1404 are extended for use of the system 1400. If illumination is desired, the light 1406 can be turned “on” via the point 1414.

In FIG. 14B, the wheel 1410 is shown rotated for shielding of the bristles 1404 and the light 1406 when the system 1400 is not in use for brushing or lighting.

In certain arrangements, the housing 1402 and the wheel 1410 are formed of an ABS plastic or other similar somewhat rigid materials. At least one of the parallel sides 1402, at a centralized portion of the side, can be formed with a somewhat elastomeric or otherwise flexible material to permit activation of the light 1406 by pressing at the portion. At another location along the portion, another similar point 1416 of the elastomeric or flexible material in the side 1402 provides an “off” switch (hereinafter the point 1414 and the point 1416 are sometimes referred to as the “on” switch and the “off” switch, respectively, but should be understood as being the points 1414, 1416 and the accessibility for powering the light 1406 by the user). The bristles 1404 are any type of materials useful for sweeping, cleaning, application or similar operations with the system 1400. The bristles 1404 and the light 1406 are retained with the wheel 1410 in appropriate and desired manner, such as by glue, retention mechanism, gripping, or other desired attachment. The light 1306 is, for example, a low-power bulb, such as an LED or other. If a screen is employed to shield the light 1306, the screen is attached with the wheel 1410 as desired, either fixed or detachable.

Although not shown in detail in FIG. 14A, the wheel 1410 contains a power source, such as a battery sufficient to power the light 1406, and a circuit connects the light 1406 the power supply and each of the switches 1414, 1416. The switches 1414, 1416 permit on/off of the circuit and power to the light 1406, as selectively desired by a user of the system 1400. The switches 1414, 1416 can alternately be located along another area of the side 1402b, on the wheel 1410 or otherwise, and a single switch can serve to provide both “on” and “off” activation if desired in the design and application. The system 1400 can be disposable once power is exhausted, or otherwise features of the system 1400 can be formed to permit replacement of parts, including, among other things, the power source, the light 1406, and the bristles 1404.

The wheel 1410 can also contain a spring mechanism (not shown in detail), connecting the housing 1402 and the wheel 1410. The spring mechanism facilitates rotation of the wheel 1410 for thereby extending and/or retracting the bristles 1410 with respect to the housing 1402.

In operation, a user handles (or otherwise manipulates) the system 1400 to push the tab 1413, rotating the wheel 1410, to expose the bristles 1404 from between the parallel sides 1402 (as positioned in FIG. 14A). The user can press the respective points 1414, 1416 to turn “on” or “off” the light 1406. When the bristles 1404 are not in use, the user rotates the wheel 1410, via the tab 1413 such that the bristles 1404 are between the parallel sides 1402 and not extended therefrom (as positioned in FIG. 14B).

Other alternatives are possible in keeping with the foregoing and all such alternatives are included herein. For example, different and varied shapes, sizes, materials, housings, configurations, pivotal elements, extension and retraction mechanisms, lighting and lights, power sources, circuitry, switches, and so forth, as well as other features such as a handle or extension of an implement can be included or provided. In the case of certain embodiments, a shroud or other connector for the cleaning element can, itself, serve as a handle. The shroud can be any of a wide variety of mechanisms that serve to retain a cleaning element. The shroud can be formed with the cleaning element, such that the shroud and cleaning element are a unitary piece. A wide variety of materials are possible for the implements. Additionally, a wide variety of lights and similar illumination elements are possible and all are included. External and internal power sources and supplies are incorporable. Replaceable elements, including lights, cleaning element, handle, battery, circuitry, switch or trigger, and other parts and units can be included. Moreover, the particular aspects of switch operations, including the design and method, means or mode of operations thereof, are variable and include all possibilities for every included application and use.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is Claimed is:

1. A system for brushing, comprising:
a bristle;
a housing containing the bristle, the housing being hand holdable; and
a light connected to the housing.

2. The system of claim 1, wherein the cleaning element is selected from the group consisting of: broom, mop, duster, cloth, bristle, painter, roller, detailer, applicator, and combination.

3. The system of claim 1, further comprising a plurality of lights.

4. The system of claim 1, further comprising a switch connected to the light for turning the light on and off.

5. The system of claim 5, wherein the switch is selected from the group consisting of: a two-position switch, separate “on” switch and an “off” switch, and combinations.

6. The system of claim 3, further comprising a switch positional in more than two positions for selectively turning on and off select ones of the plurality of lights.

7. The system of claim 1, further comprising:
a power source, electrically connected to the light.

8. The system of claim 7, wherein the power source is connected to and retained internally within the system.

9. A hand implement for work on a surface, comprising:
an elongate housing having an operational end;
a work element connected to the operational end;
a light connected to the housing for selectively illuminating the surface;
a power source contained within the housing and connected to the light; and
a switch connected to the power source for turning on and off the power source to the light.

10. A hand implement for work on a surface, comprising:
parallel sides joined by an end;
a wheel rotatably connected between the parallel sides;
a work element connected to the periphery of the wheel;
a light connected to the wheel for selectively illuminating the surface;
a power source connected to the light and contained within the wheel; and
a switch connected to the power source for turning on and off the power source to the light.

11. The implement of claim 10, wherein, via counter rotations of the wheel, either the work element is extendable from between the parallel sides to expose the work element for work on the surface or the work element is retainable between the parallel sides to shield the work element when not in use for work on the surface.

12. The implement of claim 11, wherein the switch is externally accessible on at least one of the parallel sides.

13. A method of using a hand implement, comprising the steps of:
connecting a light to a housing;
connecting a bristle to the housing; and
selectively switching on/off the light.

14. The method of claim 13, further comprising the step of selectively extending the bristle from within the housing for use of the implement.

15. The method of claim 13, further comprising the step of selectively illuminating a work surface.
